(19) United States
(12) Patent Application Publication
(10) Pub. No.: US 2014/0367137 A1
(43) Pub. Date: Dec. 18, 2014

(54) ARM ASSEMBLY FOR HOLDING AN ELECTRONIC DEVICE

(71) Applicant: Master Group Asia Ltd., Hong Kong (HK)

(72) Inventor: Suk Siu LEUNG, Hong Kong (HK)

(73) Assignee: Master Group Asia Ltd.

(21) Appl. No.: 13/920,104

(22) Filed: Jun. 18, 2013

(51) Int. Cl. H02G 3/04; H02G 1/00; F16M 13/02

(52) U.S. Cl. CPC H02G 3/045; F16M 13/022; H02G 1/00
USPC 174/68.3; 29/825

(57) ABSTRACT

An articulated arm assembly for holding an electronic device includes a base having an enclosing housing defining a first channel, and an extension having a proximal end rotatably coupled with the base. The extension has an enclosing housing defining a second channel in communication with the first channel A forearm has a proximal end rotatably coupled with a distal end of the extension. The forearm has an enclosing housing defining a third channel in communication with the second channel. A pivotable mounting plate is rotatably coupled with a distal end of the forearm for mounting thereon the electronic device. A pre-installed cable extends through the first, second and third channels, and can be entirely concealed inside the enclosing housings of the base, the extension and the forearm.

### FIELD OF THE TECHNOLOGY

The present application relates to an arm assembly for holding an electronic device.

### BACKGROUND

The conventional articulated arms for holding electronic devices need cables running between the electronic device and computer for data and power signal transmission. These cables are placed externally or partially externally along the section(s) and joint(s) of the articulated arm and tend to obstruct arm movements and the appearance of the arm.

Many existing articulated arms provide a partially covered cable channels to house the cables. However, these cables have to be routed externally at the joints between the articulated sections of the arm. Users have to route the cables along the arm body and joints, and also manage the cable slacks by themselves. With the presence of these external cables, the articulated arm cannot be moved in full ranges with respect to the articulated sections, and arm movement is restricted to a certain degree due to cable obstruction or entanglement with the arm body unless huge cable slacks are formed at the joints. However, this increases the possibilities of entanglement with external objects and affects the overall appearance of the arm.

There are a very few arms exist in the market for medical application which provide a completely covered cable channel to conceal cables fully along the articulated arm. However, the arm sections and joints are thicker and more bulky than the standard arms used in general office environment. The arm joints must spare a large hollow section at the center to let cables with plugs and sockets running therethrough. These joints are formed with outer circular bearings to provide rotate function. Users still have to routes the cables and manage the cable slacks by themselves.

Hence, there is a need to produce an arm assembly that is cable-management free, slim in size, and suitable for use in home and office environments.

The above description of the background is provided to aid in understanding an arm assembly for holding an electronic device, but is not admitted to describe or constitute pertinent prior art to the arm assembly for holding an electronic device disclosed in the present application, or consider any cited documents as material to the patentability of the claims of the present application.

### SUMMARY

According to one aspect, there is provided an articulated arm assembly for holding an electronic device. The articulated arm assembly includes a base having an enclosing housing defining a first cable channel therethrough, an extension having a proximal end rotatably coupled with the base and an enclosing housing defining a second cable channel therethrough in communication with the first cable channel, a forearm having a proximal end rotatably coupled with a distal end of the extension and an enclosing housing defining a third cable channel therethrough in communication with the second channel, a pivotable mounting plate rotatably coupled with a distal end of the forearm for mounting thereon the electronic device, and at least one removable cable extending through the first, second and third cable channels, and concealed inside the enclosing housings of the base, the extension and the forearm.

According to another aspect, there is provided an arm assembly including a base having an enclosing housing defining a first channel therethrough, a forearm rotatably coupled with the base and having an enclosing housing defining a second channel therethrough in communication with the first channel, and at least one removable cable extending through the first and second channels and concealed inside the enclosing housings of the base and the forearm.

The enclosing housing of the base may be in the form of a tubular end and has a central shaft formed therein. The central shaft and the tubular end define an annular channel about which the cable freely can move.

A proximal end of the forearm may be provided with a tubular end and a central receptacle formed therein for receiving the central shaft of the base, whereby the forearm is rotatable about the central shaft of the base. The central receptacle and the tubular end at the proximal end of the forearm define a C-shaped channel about which the cable freely can move.

The arm assembly may further include an extension rotatably coupled with and between the base and the forearm. The extension has an enclosing housing defining a third channel therethrough, wherein the first, second and third channels are in communication with each other. The cable can extend through the first, second and third channels, whereby the cable can be concealed inside the enclosing housings of the base, the extension and the forearm.

A proximal end of the extension may be provided with a tubular end and a central receptacle formed therein for receiving the central shaft of the base, whereby the extension can be rotatable about the central shaft of the base.

The tubular end and the central shaft of the base, and the tubular end and the central receptacle at the proximal end of the extension together define an axially extending annular channel about which the cable can freely move.

A distal end of the extension may be provided with a tubular end and a central shaft formed therein. The central receptacle at the proximal end of the forearm can be adapted to receive therein the central shaft of the extension, whereby the forearm can be rotatable about the central shaft of the extension. The tubular end and the central shaft at the distal end of the extension, and the tubular end and the central receptacle at the proximal end of the forearm together define an axially extending C-shaped channel about which the cable can freely move.

The cable may be pre-installed in a factory. The cable may be formed in one single piece. The cable may include a plurality of cable sections electrically connected together by one or more electrical connectors.

A sidewall of the enclosing housing of the base may be mounted thereon with a socket to which a proximal end of the cable can be connected. A sidewall at a distal end of the enclosing housing of the forearm may be mounted thereon with a socket to which a distal end of the cable can be connected.

A proximal end of the cable may be provided with a plug/socket terminal which can be disposed outside the enclosing housing of the base. A distal end of the cable may be provided with a plug/socket terminal which can be disposed outside a distal end of the enclosing housing of the forearm.

The arm assembly may further include a pivotable mounting plate rotatably coupled with a distal end of the forearm for mounting thereon an electronic device.

The arm assembly may further include a cover for covering an opening formed on the tubular end at the proximal end of the forearm where the C-shaped channel is located.

According to yet another aspect, there is provided a method for manufacturing an arm assembly for holding an electronic device. The method includes the steps of forming a base having an enclosing housing defining a first channel therethrough, forming a forearm rotatably coupled with the base and having an enclosing housing defining a second channel therethrough in communication with the first channel, forming a pivotable mounting plate rotatably coupled with the forearm, and pre-installing a cable through the first and second channels and entirely concealing the cable inside the enclosing housings of the base and the forearm.

Although the arm assembly for holding an electronic device disclosed in the present application is shown and described with respect to certain embodiments, it is obvious that equivalents and modifications will occur to others skilled in the art upon the reading and understanding of the specification. The present application includes all such equivalents and modifications, and is not limited only by the scope of the claims.

### BRIEF DESCRIPTION OF THE DRAWINGS

Specific embodiments of the arm assembly for holding an electronic device disclosed in the present application will now be described by way of example with reference to the accompanying drawings wherein:

FIG. 1 is a perspective view of an articulated arm assembly according to an embodiment of the present application.

FIG. 2 shows the perspective views of three embodiments of a base of the articulated arm assembly.

FIG. 3 shows the exploded views of two embodiments of a desk base of the articulated arm assembly.

FIG. 4 shows the exploded views of two embodiments of a wall-mounting base of the articulated arm assembly.

FIG. 5 shows the perspective views of an extension and a forearm of the articulated arm assembly according to an embodiment of the present application.

FIG. 6 is an exploded view of the extension of the articulated arm assembly according to an embodiment of the present application.

FIG. 7 is an exploded view of the forearm of the articulated arm assembly according to an embodiment of the present application.

FIG. 8 is an exploded view of an integrated pivot of the articulated arm assembly according to an embodiment of the present application.

FIG. 9a shows an exploded view and a perspective view of the joint between the forearm and the base of the articulated arm assembly according to an embodiment of the present application.

FIG. 9b shows an exploded view and a perspective view of the joint between the extension and the base of the articulated arm assembly according to an embodiment of the present application.

FIG. 10 shows a perspective view and a cross sectional view of an annular cable channel of the articulated arm assembly according to an embodiment of the present application.

FIG. 11 shows an exploded view and a perspective view of the joint between the forearm and the extension of the articulated arm assembly according to an embodiment of the present application.

FIG. 12 shows a perspective view and a cross sectional view of an annular cable channel of the forearm and the extension of the articulated arm assembly according to an embodiment of the present application.

FIG. 13 is an exploded view a joint between the integrated pivot and the forearm of the articulated arm assembly according to an embodiment of the present application.

FIG. 14 shows two cross sectional views of the articulated arm assembly having a cable with extended plug/socket terminals and surface-mounting socket terminals according to two embodiments of the present application.

FIG. 15a shows the perspective views of the forearm and the extension, and the joint between the extension and the base showing the routing of the cable with extended plug/socket terminals according to an embodiment of the present application.

FIG. 15b shows the perspective views of the forearm and the extension, and the joint between the extension and the base showing the routing of the cable with surface-mounting socket terminals according to an embodiment of the present application.

FIG. 16 is an exploded view of the articulated arm assembly according to an embodiment of the present application.

FIG. 17 shows the ranges of movement of the integrated pivot according to an embodiment of the present application.

FIG. 18 shows the ranges of movement of the forearm and extension according to an embodiment of the present application.

### DETAILED DESCRIPTION

Reference will now be made in detail to a preferred embodiment of the arm assembly for holding an electronic device disclosed in the present application, examples of which are also provided in the following description. Exemplary embodiments of the arm assembly for holding an electronic device disclosed in the present application are described in detail, although it will be apparent to those skilled in the relevant art that some features that are not particularly important to an understanding of the arm assembly for holding an electronic device may not be shown for the sake of clarity.

Furthermore, it should be understood that the arm assembly for holding an electronic device disclosed in the present application is not limited to the precise embodiments described below and that various changes and modifications thereof may be effected by one skilled in the art without departing from the spirit or scope of the appended claims. For example, elements and/or features of different illustrative embodiments may be combined with each other and/or substituted for each other within the scope of this disclosure and appended claims.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element, or is in mechanical or electrical communication with another element.

In addition, improvements and modifications which may become apparent to persons of ordinary skill in the art after reading this disclosure, the drawings, and the appended claims are deemed within the spirit and scope of the appended claims

FIG. 1 is a perspective view of an articulated arm assembly according to an embodiment of the present application. The articulated arm assembly may include a base 11, an articulated section 12 and an integrated pivot 13.

The base 11 may be in the form of a desk-mounting base for holding the articulated section 12 and the integrated pivot 13 on a horizontal surface such as a desktop, or a wall-mounting base for holding the articulated section 12 and the integrated pivot 13 on a vertical surface such as a wall.

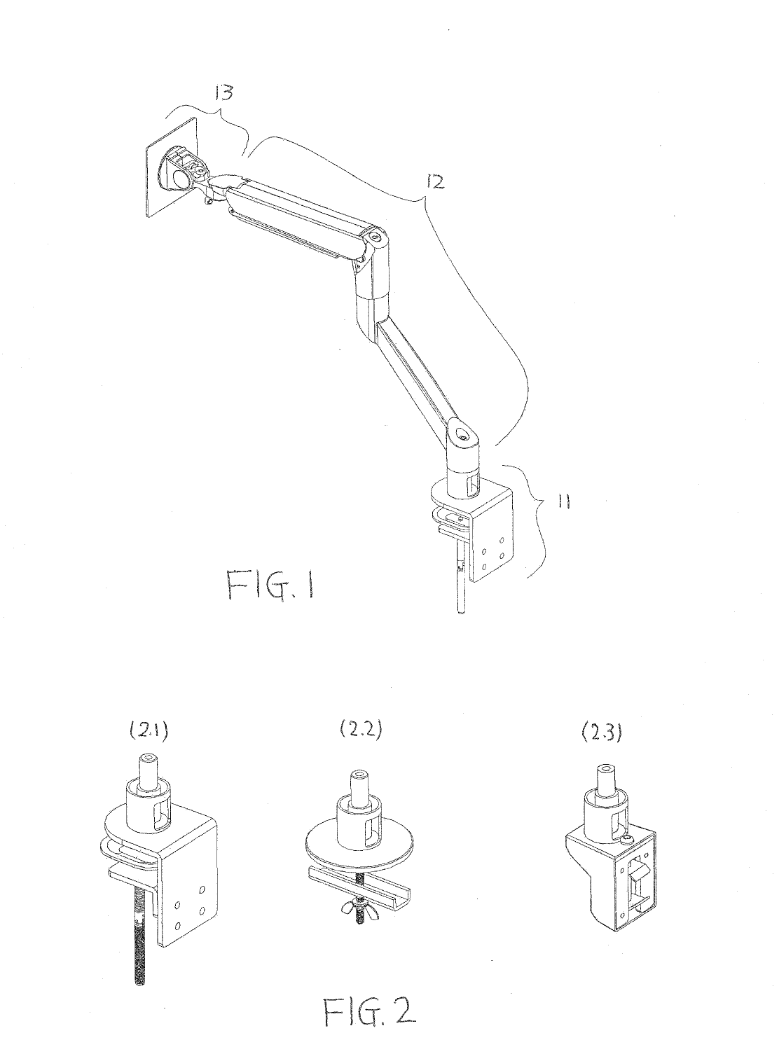

FIG. 2 shows the perspective views of three embodiments of the base 11 of the articulated arm assembly. The desk-mounting base may be of clamp type 21 for mounting the base at a desktop edge, or grommet type 22 for mounting the base to a desktop surface by a bolt.

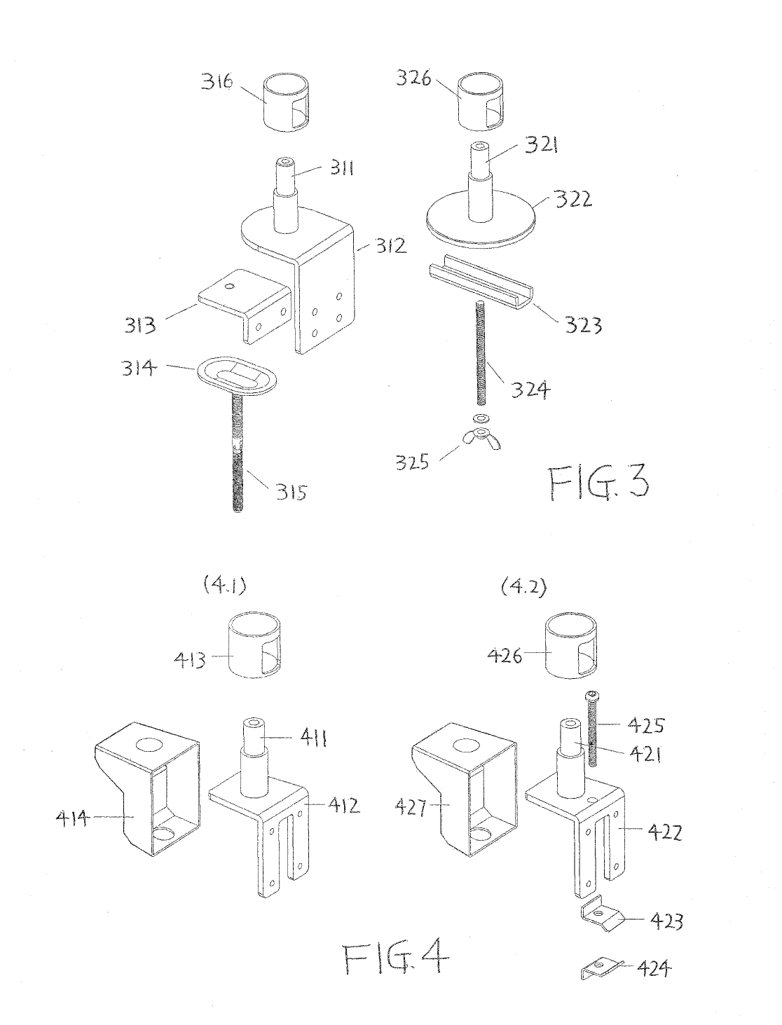

FIG. 3 shows the exploded views of two embodiments of the desk-mounting base of the articulated arm assembly.

The desk clamp 21 may include a stepped central shaft 311, which is a shaft having an outer annular stepped portion, a top L-shaped bracket 312, a bottom bracket 313, a fixing plate 314, an adjustment screw 315 and an enclosing housing 316. The enclosing housing 316 defines a cable channel therethrough. The enclosing housing 316 can be in the form of a tubular end. The central shaft 311 may be formed inside the tubular end in a coaxial relationship. The central shaft and the tubular end define an annular channel about which cable can freely move. The top L-shaped bracket 312 and the fixing plate 314 can form a clamp to mount the base on to the desktop. The distance between the top L-shaped bracket 312 and the fixing plate 314 can be adjusted with the adjustment screw 315 to match with different thicknesses of desktop.

The desk grommet 22 may include a stepped central shaft 321, a top flat bracket 322, a U-shaped bottom bar 323, a threaded rod 324, a butterfly-shaped nut 325 and an enclosing housing 326. The top flat bracket 322, the U-shaped bottom bar 323 and the butterfly-shaped nut 325 form a fixing bolt for mounting the base on to the desktop. The distance between the top flat bracket 322 and the U-shaped bottom bar 323 can be adjusted with the butterfly-shaped nut 325 threaded on the threaded rod 324 to match with different thicknesses of desktop.

FIG. 4 shows the exploded views of two embodiments of a wall-mounting base of the articulated arm assembly. The wall-mounting base 23 may be of flat-wall type 41 for mounting the base on a flat vertical surface, or slat-wall type 42 for mounting the base on a slat-wall surface.

The flat-wall mounting base 41 may include a stepped central shaft 411, a top L-shaped vertical-mounting bracket 412, an enclosing housing 413 in the form of a tubular end, and a bracket cover 414. The top L-shaped vertical-mounting bracket can be directly mounted on a vertical surface.

The slat-wall mounting base 42 may include a stepped central shaft 421, a top L-shaped vertical-mounting bracket 422, a fixed upper clip 423, an adjustable lower clip 424, an adjustment screw 425, an enclosing housing 426 in the form of a tubular end, and a bracket cover 427. The top L-shaped vertical-mounting bracket can be mounted on a vertical slat-wall surface. The fixed upper clip and the adjustable lower clip can form a clamp for mounting the wall-mounting base 42 on a slat-wall. The distance between the clamps 423 & 424 can be adjusted by the adjustment screw 425 to match with different types of slat-wall with different slat rail patterns.

The top end of the base 41, 42 with the stepped central shaft can be connected to the articulated section 12. The articulated section 12 refers to the section(s) connecting between the base 11 and the integrated pivot 13. The articulated section 12 can be used to support the integrated pivot 13 on the base. The articulated section 12 can be manipulated to extend the integrated pivot 13 from the base horizontally and vertically.

FIG. 5 shows the perspective views of the extension 51 and the forearm 52 of the articulated arm assembly according to an embodiment of the present application. The articulated section 12 may include only one forearm 52, or it may include both the forearm 52 and the extension 51.

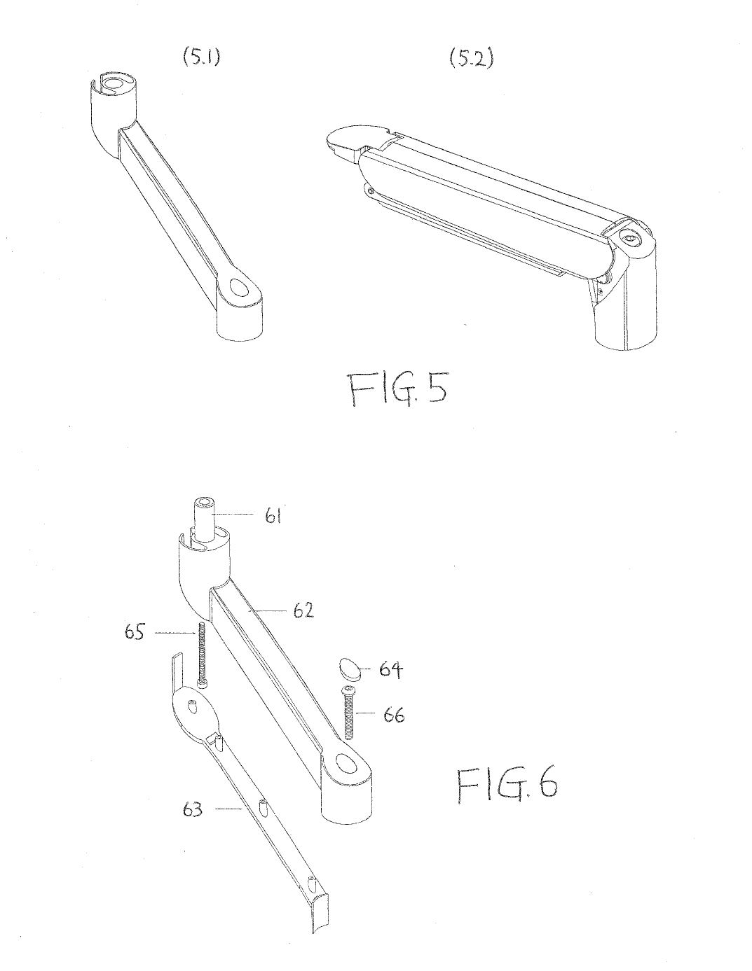

FIG. 6 is an exploded view of the extension 51 of the articulated arm assembly according to an embodiment of the present application. The extension 51 has a lower or proximal end and an upper or distal end.

The extension 51 may include at its distal end a central shaft 61, an extension body 62, a bottom cover 63, a top screw cover 64, a first adjustment screw 65, a second adjustment screw 66 and a ring spacer 67.

The extension 5 may be rotatably coupled with and between the base 11 and the forearm 52. The extension may have an enclosing housing 62, 63 defining a third channel therethrough. The first, second and third channels are in communication with each other, whereby one or more removable cables can extend through the first, second and third channels and can be concealed inside the enclosing housings of the base, the extension and the forearm.

FIG. 7 is an exploded view of the forearm 52 of the articulated arm assembly according to an embodiment of the present application. The forearm has a lower or proximal end and an upper or distal end.

The forearm 52 may include a swing head holder 71, a top frame 72, a bottom frame 73, a left side cover 74, a right side cover 75, a gas spring 76, a knuckle joint 77, a knuckle joint pin 78, a main joint 79, three pins 710, two locking nuts 711, an adjustment screw 712, a main joint cover 713 and a circular spacer 714. The top frame 72, the bottom frame 73, the left side cover 74, the right side cover 75 together form an enclosing housing defining a cable channel extending therethrough. The cable channel of the forearm 52 may be in communication with the cable channel of the base 11. Cables may extend through the cable channels, and can be concealed inside the enclosing housings of the base and the forearm.

As illustrated in FIG. 18, the extension 51 can provide a lateral 360° swing movement of the forearm 52 about the base. Furthermore, the forearm 52 can provide both a lateral 360° swing movement and a vertical movement of the integrated pivot 13 from the base 11 or from a distal end of the extension 51.

The forearm 52 can provide adjustable uplifting force by adjusting the knuckle joint along the main joint vertically with the adjustment screw to lift up the integrated pivot 13 mounted thereon with an electronic device such as an electronic display, an output device, or a flat panel monitor.

The uplifting force of the forearm 52 can be adjusted to a counterbalance force to hold the integrated pivot 13 and the mounted electronic device within preset ranges of load and size in any heights, and maintain it in a stable position within the preset ranges of vertical movement.

In the articulated section having only the forearm 52, the swing head holder 71 of the forearm can be connected to the integrated pivot, and the main joint of the forearm can be connected to the base.

In the articulated section having both the forearm 52 and the extension 51, the swing head holder of the forearm can be connected to the integrated pivot, and a proximal end of the extension can be connected to the base. The main joint of the forearm can be connected to the central shaft of the extension.

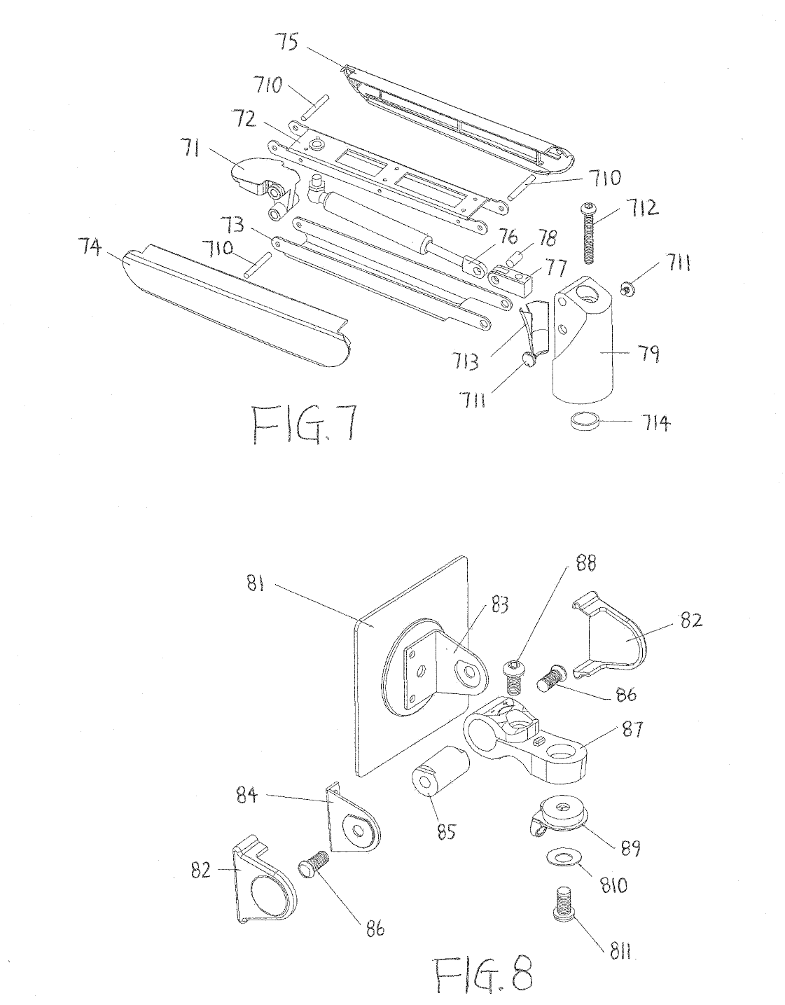

FIG. 8 is an exploded view of the integrated pivot 13 of the articulated arm assembly according to an embodiment of the present application. The integrated pivot 13 may include a mounting plate 81, two side covers 82, a right pivot support bracket 83, a left pivot support bracket 84, a centre pin 85, two locking screws 86, a swing head 87, an adjustment screw 88, a cable ring or hook 89, a washer 810 and a locking screw 811. The mounting plate can be used for mounting thereon the electronic device. The integrated pivot 13 can be rotatably coupled with the front or distal end of the forearm of the arm assembly.

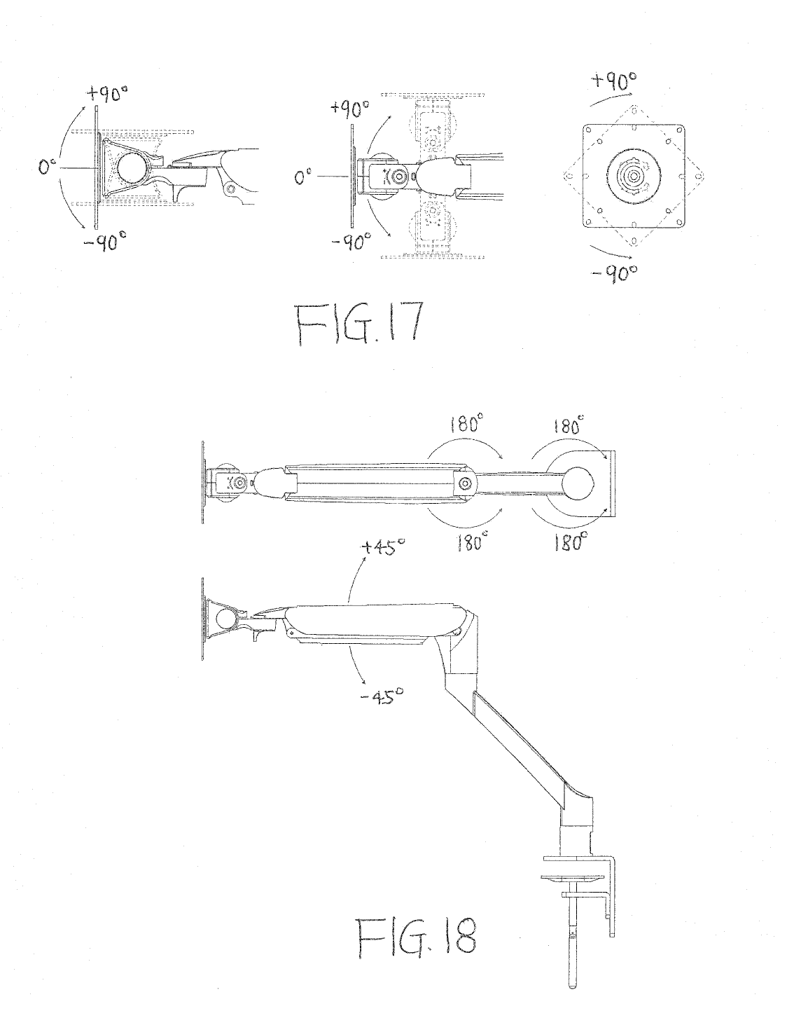

As illustrated in FIG. 17, the integrated pivot 13 can provide left and right rotation, up-tilting and down-tilting movement for the mounted electronic device. The integrated pivot may be able to support the electronic device within the preset ranges of load and size with the adjustment screw 88. The swing head 87 of the integrated pivot can be connected to the swing head holder 71 of the forearm.

The base 11 and the articulated section 12 can be connected to form an articulated structure with a lateral rotation joint.

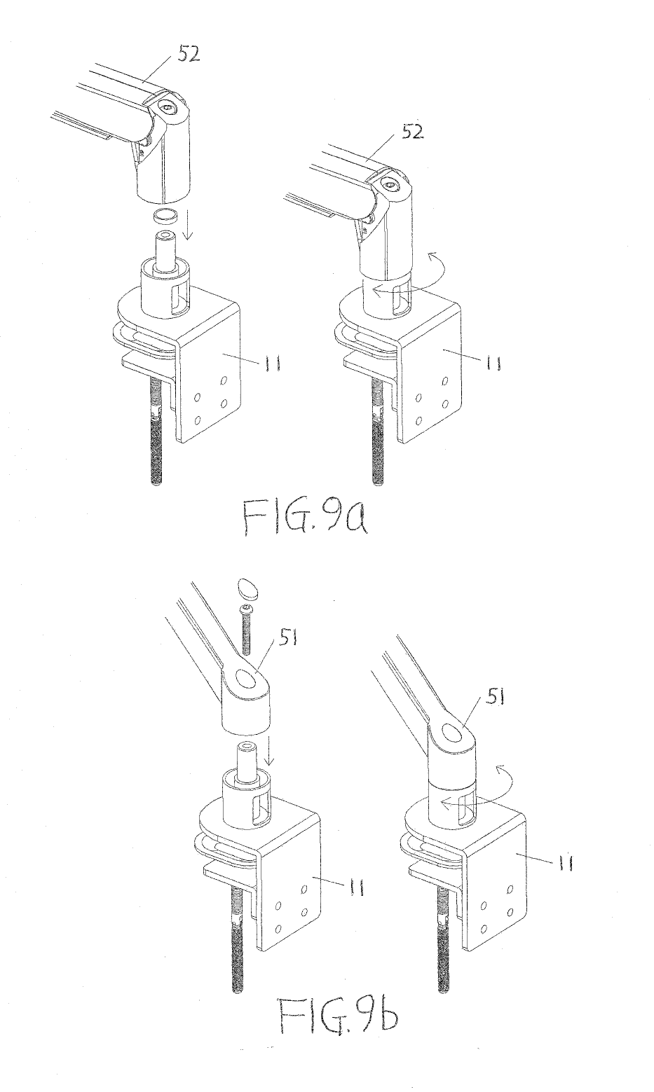

FIG. 9a shows an exploded view and a perspective view of the rotation joint between the forearm 52 and the base 11 of the articulated arm assembly according to an embodiment of the present application.

For the articulated section having only the forearm 52, the central shaft of the base can work as a platform axial shaft of the rotation joint between the forearm 52 and the base 11. The main joint 79 of the forearm may be provided with a tubular end and a central receptacle 1122, as shown in FIG. 12, for receiving therein the central shaft of the base to form the rotation joint between the base and the articulated section. Hence, the forearm can be rotatable laterally about the central shaft on the base.

FIG. 9b shows an exploded view and a perspective view of the joint between the extension and the base of the articulated arm assembly according to an embodiment of the present application.

For the articulated section having both the forearm 52 and the extension 51, the central shaft of the base can work as a platform axial shaft of the rotation joint between the extension 51 and the base 11. The proximal end of the extension may have a central receptacle for receiving therein the central shaft of the base to form a rotation joint between the base and the extension. Hence, the extension can be rotatable laterally about the central shaft on the base.

The tubular end and the central shaft of the base, and the tubular end and the central receptacle at the proximal end of the extension together define an axially extending annular channel about which the cable can freely move.

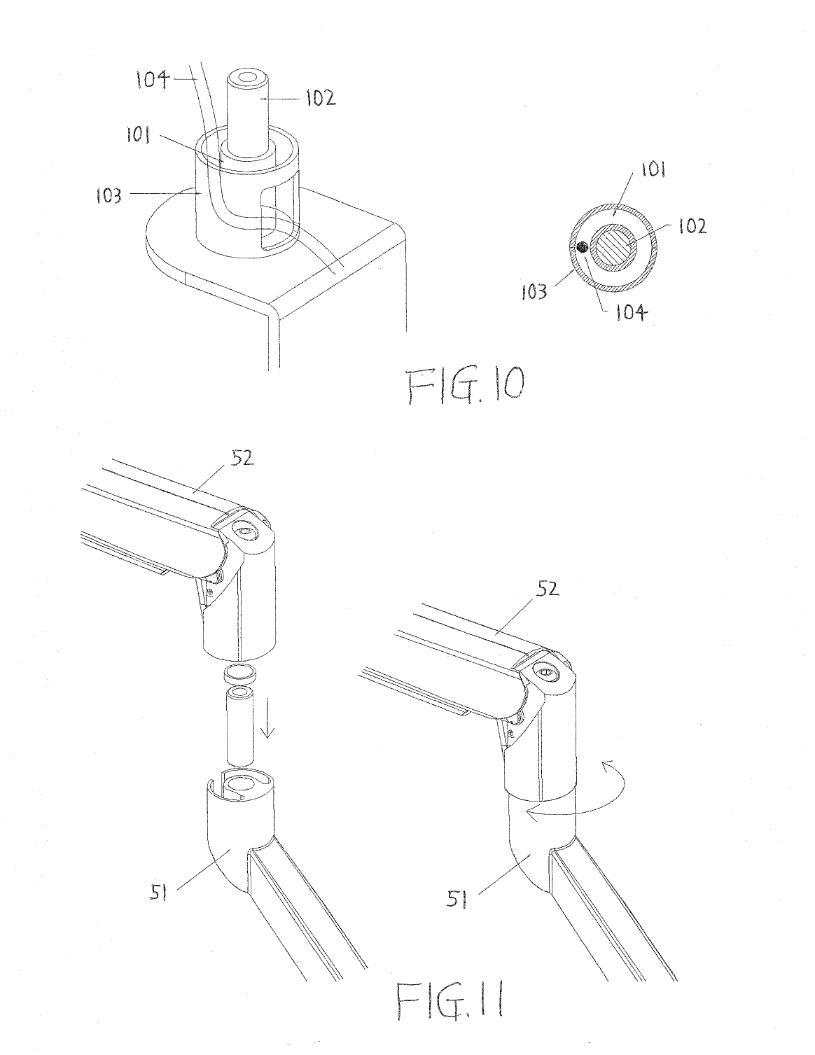

FIG. 10 shows a perspective view and a cross sectional view of an annular cable channel 101 of the articulated arm assembly according to an embodiment of the present application. The annular cable channel 101 may be formed between the central shaft 102 and the enclosing housing 103. The annular cable channel 101 can provide a channel for fully concealing cables 104 passing therethrough. The annular cable channel 101 can provide an annular space about which the cables 104 can freely move. This may reduce the tension that may be generated on the cables when the extension rotates on the base. It can be realized that the cables can be fully concealed inside the rotation joint between the articulated section 12 and the base 11.

The extension 51 and the forearm 52 can be connected to form an articulated structure with a lateral rotation joint.

FIGS. 11 and 12 show the rotation joint between the forearm 52 and the extension 51 of the articulated arm assembly according to an embodiment of the present application.

A central shaft 11a.2 may be provided at the distal end of the extension and can work as a platform axial shaft of the rotation joint between the extension 51 and the forearm 52. The central receptacle 1122 at the proximal end of the forearm can receive therein the central shaft 1112 at the distal end of the extension to form a rotation joint between the forearm and the extension. Hence, the forearm can be rotatable laterally about the central shaft of the extension.

The extension 51 may have a C-shaped cable channel 11a.1 formed between the central shaft 1112 and a tubular end 1113 of the extension. The forearm 52 may also have a C-shaped cable channel 1121 formed between the central receptacle 1122 and a tubular end 1123 of the forearm. The central shaft 1112 and a tubular end 1113 of the extension, and the central receptacle 1122 and a tubular end 1123 of the forearm together can form an axially extending C-shaped cable channel 1111 and 1112 for fully concealing cables 1114, 1124 routing through the rotation joint of the forearm and the extension.

The axially extending C-shaped cable channel 1111 and 1112 can provide an axially elongated C-shaped space about which the cables 1114, 1124 can freely move. This may reduce the tension that may be generated on the cables when the forearm rotates on the extension.

The main joint cover 1115 can be removable from the main joint to allow cable routing inside the C-shaped cable channel at the side of the central receptacle of the forearm.

The bottom cover 1125 of the extension can be removed from the extension to allow cable routing inside the C-shaped cable channel at the side of the central shaft of the extension.

The cables can be fully concealed at the rotation joint between the forearm and the extension when the main joint cover 1115 of the forearm is attached to the main joint and the bottom cover 1125 of the extension is attached to the extension.

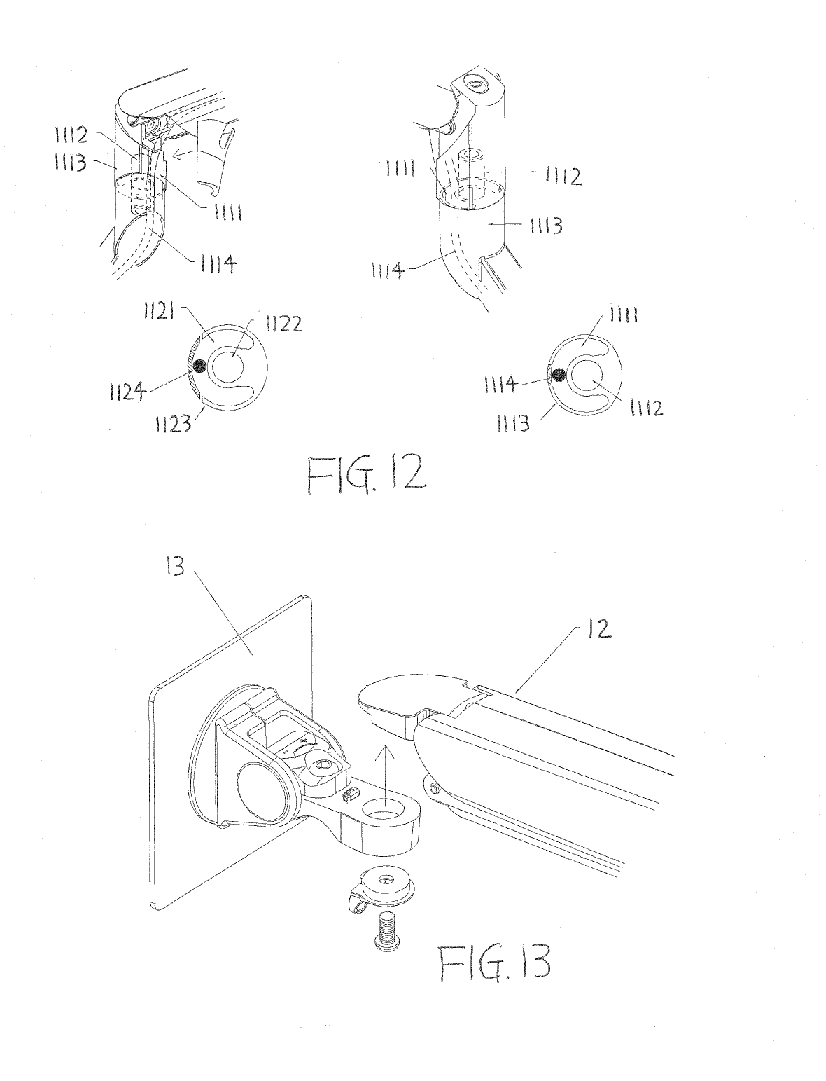

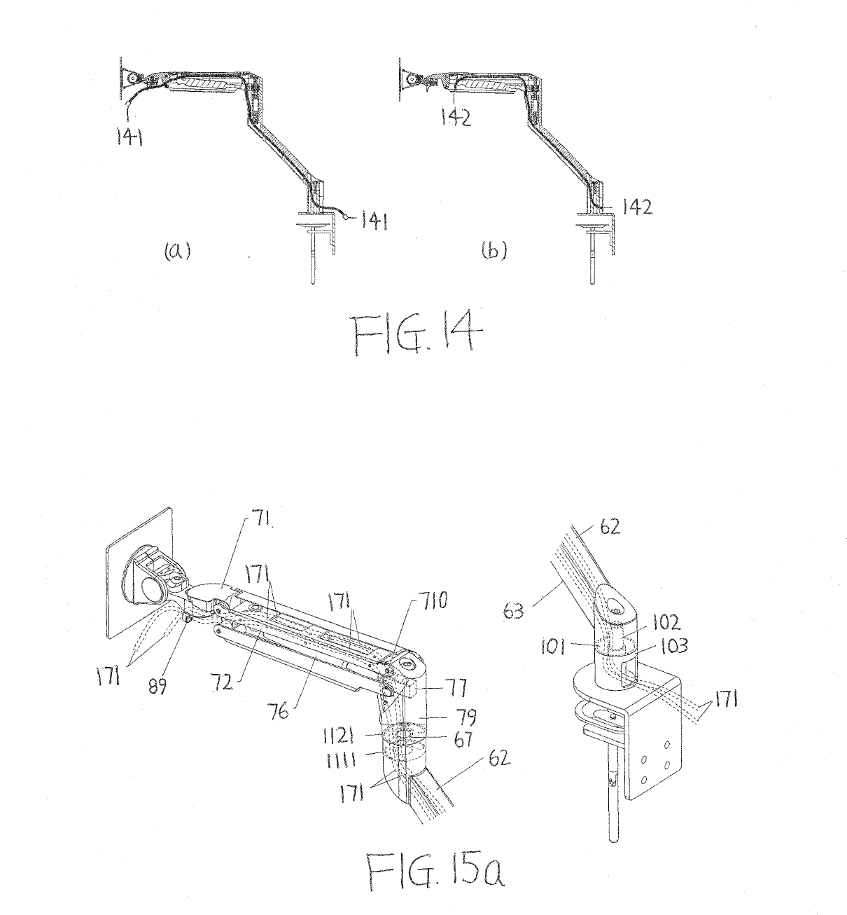

FIG. 13 is an exploded view a joint between the integrated pivot and the forearm of the articulated arm assembly according to an embodiment of the present application. The integrated pivot 13 and the articulated section 12 can be connected to form an articulated structure with a lateral rotation joint.

A downwardly extending shaft of the swing head holder 71 may work as a platform axial shaft of the rotation joint between the articulated section 12 and the integrated pivot 13. The swing head 87 of the integrated pivot may have a shaft receptacle for receiving therein the downwardly extending shaft of the swing head holder 71 to form a rotation joint between the articulated section and the integrated pivot. Hence, the integrated pivot can be rotatable laterally about the platform axial shaft on the articulated section.

The arm assembly may come with one or more cables. The cable may be in one single piece, or it may include a plurality of cable sections electrically connected together by one or more electrical connectors.

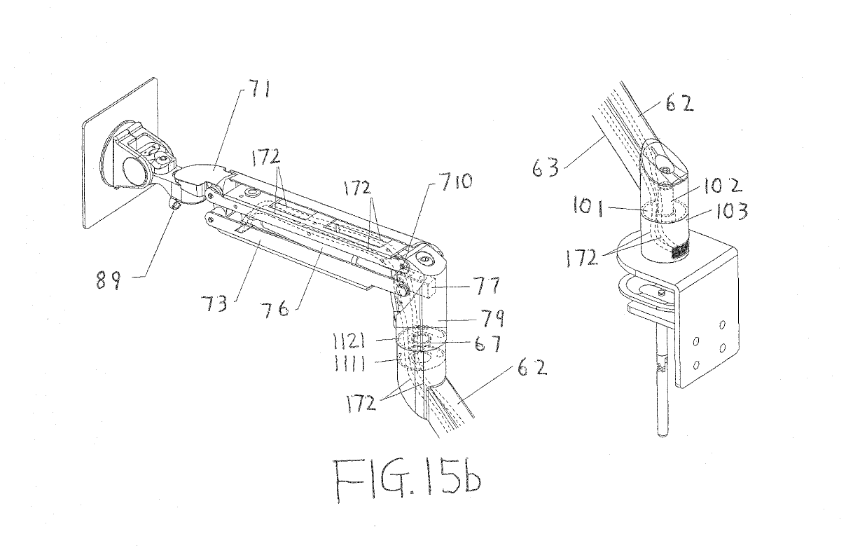

FIG. 14 shows two cross sectional views of the articulated arm assembly having a cable with extended plug/socket terminals 141 and surface-mounting socket terminals 142 according to two embodiments of the present application. The cables may be data and power cables that can be pre-installed in the arm assembly in the following ways:

(a) Extended flexible cables with the plug/socket terminals 141 from the forearm and base of the arm assembly. According to the illustrated embodiment, a proximal end of the cable is provided with a plug/socket terminal which is disposed outside the enclosing housing of the base, and a distal end of the cable is provided with a plug/socket terminal which is disposed outside a distal end of the enclosing housing of the forearm.

(b) Socket terminals 142 mounted on the surfaces of the forearm and the base of the arm assembly. According to the illustrated embodiment, a sidewall of the enclosing housing of the base is mounted thereon with a socket to which a proximal end of the cable is connected, and a sidewall at a distal end of the enclosing housing of the forearm is mounted thereon with a socket to which a distal end of the cable is connected.

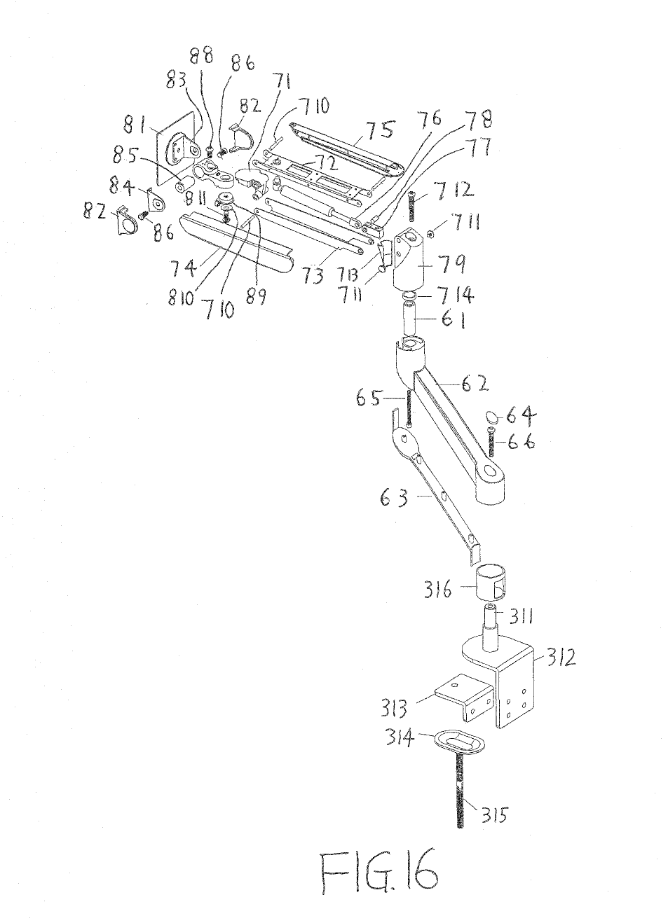

FIG. 15a shows the type (a) routing of cables 171 with plug/socket terminals in the arm assembly. The cables are passed through the cable hook 89 and through the swing head holder 71. The cables are placed underneath the top frame 72 but above the gas spring 76. The cables are then turned downwards when entering the main joint 79 at the position just below the pin 710 of the main joint. The cables are put at the side of the knuckle joint 77. The cables are passed through the C-shaped cable channel 1111 at the main joint of the forearm, and through the rotation joint formed between the forearm and the extension (Refer to FIG. 12). The cables are passed through the spacer 67 and through the C-shaped cable channel 1111 in the extension. The cables are placed underneath the extension body section 62 and above the extension bottom Cover 63. The cables are passed through the proximal end of the extension between the receptacle and the tubular end, and then through the rotation joint formed between the extension and the base (Refer to FIG. 10). The cables are passed through the annular cable channel 101 between the central shaft 102 and the enclosing housing 103 of the base, and finally through an outlet of the housing 103 or through a bottom portion of the base.

FIG. 15b shows the type (b) routing of cables 172 with surface mounted sockets on the forearm and the base in the arm assembly. The surface mounted socket at the distal end of the cables is mounted at the bottom frame 73 of the forearm. The cables are routed upwards above the gas spring 76, and placed underneath the top frame 72. The cables are then turned downwards when entering the main joint 79 at the position just below the pin 710 of the main joint 79. The cables are put at the sides of the knuckle joint 77. The cables are passed through the C-shaped cable channel 1121 at the main joint of the forearm, and then through the rotation joint formed between the forearm and the extension (Refer to FIG. 12). The cables are passed through the spacer 67 and through the C-shaped cable channel 1111 in the extension. The cables are placed underneath the extension body section 62 and above the extension bottom cover 63. The cables are passed through the proximal end of the extension between the receptacle and the tubular end, and then through the rotation joint formed between the extension and the base (Refer to FIG. 10). The cables are passed through the annular cable channel 101 between the central shaft 102 and the enclosing housing 103 of the base. The surface mounted socket at the proximal end of the cables can be mounted at an outlet of the enclosing housing or through a bottom portion of the base.

It is shown that the cables can be fully concealed along (i) the forearm 52, (ii) the rotation joint between the forearm and extension having a C-shaped cable channel (refer to FIG. 11), (iii) the extension 51, (iv) the rotation joint between the extension and base having an annular cable channel (refer to FIG. 9b), and (v) the base 11.

The arm assembly for holding an electronic device can be manufactured by (i) forming a base having an enclosing housing defining a first channel extending therethrough; (ii) forming a forearm rotatably coupled with the base, the forearm having an enclosing housing defining a second channel extending therethrough and in communication with the first channel; (iii) forming a pivotable mounting plate rotatably coupled with the forearm; and (iv) pre-installing a cable through the first and second channels, and entirely concealing the cable inside the enclosing housings of the base and the forearm.

The viewing angle adjustment refers to the ranges of movement of the integrated pivot for left and right swing, up and down tilt, and rotation of the attached electronic output devices or display. The height and distance adjustment refers to the radial and vertical movement of the forearm with respect to the base or extension, and the radial movement of the extension with respect to the base.

The ranges of movement of the arm assembly having both the forearm and the extension are listed as follows:

Pivot: Mounting plate can move +/−90° swing, +/−90° tilt, +/−90° rotate

Forearm: +/−180° swing, +/−45° lift up and down (along the extension)

Extension: +/−180° swing (along the base)

The ranges of movement of the arm assembly having only the forearm (without the extension) are listed as follows:

Pivot: Mounting plate can move +/−90° swing, +/−90° tilt, +/−90° rotate

Forearm: +/−180° swing, +/−45° lift up and down (along the base)

The articulated arm assembly with internal data and power cables or other signal transmission medium for mounting electronic displays or other kind of electronic output devices, in particular the flat panel monitor, TV and tablet PC to the computer or other kind of electronic processer devices on horizontal or vertical surfaces, in particular the desktop, wall or pole. It permits free movement in pre-set ranges without the obstruction from cables and free of cable management. The internal cables can be fully concealed along the sections and joints within the specific cable channels of the arm assembly. This arm assembly is slim in size, and suitable for use in office, home, commercial and industrial environments.

The work of cable routing, slacks of cables are all managed in factory, and no cable management work needs to be done by users. Users can simply hook up the electronic device to the arm assembly at one end (the distal end of the forearm), and the computer to the arm assembly at the other end (the base mounting end) without taking care of the cables running along the arm. The arm can move freely to the pre-set maximum range without obstruction from cables on all joints including the vertical movement joint and the rotation joints of the arm assembly. The cables are concealed along the joint(s) and section(s) to provide a better appearance without any cables exposing out of the arm assembly.

While the arm assembly for holding an electronic device disclosed in the present application has been shown and described with particular references to a number of preferred embodiments thereof, it should be noted that various other changes or modifications may be made without departing from the scope of the appending claims.

What is claimed is:

1. An articulated arm assembly for holding an electronic device, the articulated arm assembly comprising:
(a) a base having an enclosing housing defining a first cable channel therethrough;
(b) an extension having a proximal end rotatably coupled with the base, the extension having an enclosing housing defining a second cable channel therethrough in communication with the first cable channel;
(c) a forearm having a proximal end rotatably coupled with a distal end of the extension, the forearm having an enclosing housing defining a third cable channel therethrough in communication with the second channel;
(d) a pivotable mounting plate rotatably coupled with a distal end of the forearm for mounting thereon the electronic device; and
(e) at least one removable cable extending through the first, second and third cable channels, and concealed inside the enclosing housings of the base, the extension and the forearm.

2. An arm assembly comprising:
(a) a base having an enclosing housing defining a first channel therethrough;
(b) a forearm rotatably coupled with the base, the forearm having an enclosing housing defining a second channel therethrough in communication with the first channel; and
(c) at least one removable cable extending through the first and second channels and concealed inside the enclosing housings of the base and the forearm.

3. The arm assembly as claimed in claim 2, wherein the enclosing housing of the base is in the form of a tubular end and has a central shaft formed therein, the central shaft and the tubular end define an annular channel about which the cable freely moves.

4. The arm assembly as claimed in claim 3, wherein a proximal end of the forearm is provided with a tubular end and a central receptacle formed therein for receiving the central shaft of the base, whereby the forearm is rotatable about the central shaft of the base.

5. The arm assembly as claimed in claim 4, wherein the central receptacle and the tubular end at the proximal end of the forearm define a C-shaped channel about which the cable freely moves.

6. The arm assembly as claimed in claim 5, further comprising an extension rotatably coupled with and between the base and the forearm, the extension having an enclosing housing defining a third channel therethrough, wherein the first, second and third channels are in communication with each other, and the cable extends through the first, second and third channels, whereby the cable is concealed inside the enclosing housings of the base, the extension and the forearm.

7. The arm assembly as claimed in claim 6, wherein a proximal end of the extension is provided with a tubular end and a central receptacle formed therein for receiving the central shaft of the base, whereby the extension is rotatable about the central shaft of the base.

8. The arm assembly as claimed in claim 7, wherein the tubular end and the central shaft of the base, and the tubular end and the central receptacle at the proximal end of the extension together define an axially extending annular channel about which the cable freely moves.

9. The arm assembly as claimed in claim 6, wherein a distal end of the extension is provided with a tubular end and a central shaft formed therein, the central receptacle at the proximal end of the forearm is adapted to receive therein the central shaft of the extension, whereby the forearm is rotatable about the central shaft of the extension.

10. The arm assembly as claimed in claim 9, wherein the tubular end and the central shaft at the distal end of the extension, and the tubular end and the central receptacle at the proximal end of the forearm together define an axially extending C-shaped channel about which the cable freely moves.

11. The arm assembly as claimed in claim 2, wherein the cable is pre-installed in a factory.

12. The arm assembly as claimed in claim 2, wherein the cable is in one single piece.

13. The arm assembly as claimed in claim 2, wherein the cable comprises a plurality of cable sections electrically connected together by one or more electrical connectors.

14. The arm assembly as claimed in claim 2, wherein a sidewall of the enclosing housing of the base is mounted thereon with a socket to which a proximal end of the cable is connected.

15. The arm assembly as claimed in claim 2, wherein a sidewall at a distal end of the enclosing housing of the forearm is mounted thereon with a socket to which a distal end of the cable is connected.

16. The arm assembly as claimed in claim 2, wherein a proximal end of the cable is provided with a plug/socket terminal which is disposed outside the enclosing housing of the base.

17. The arm assembly as claimed in claim 2, wherein a distal end of the cable is provided with a plug/socket terminal which is disposed outside a distal end of the enclosing housing of the forearm.

18. The arm assembly as claimed in claim 2, further comprising a pivotable mounting plate rotatably coupled with a distal end of the forearm for mounting thereon an electronic device.

19. The arm assembly as claimed in claim 5, further comprising a cover for covering an opening formed on the tubular end at the proximal end of the forearm where the C-shaped channel is located.

20. A method for manufacturing an arm assembly for holding an electronic device, the method comprising the steps of:
(a) forming a base having an enclosing housing defining a first channel therethrough;
(b) forming a forearm rotatably coupled with the base, the forearm having an enclosing housing defining a second channel therethrough in communication with the first channel;
(c) forming a pivotable mounting plate rotatably coupled with the forearm; and
(d) pre-installing a cable through the first and second channels, and entirely concealing the cable inside the enclosing housings of the base and the forearm.
